(19) United States
(12) Patent Application Publication
(10) Pub. No.: US 2017/0030391 A1
(43) Pub. Date: Feb. 2, 2017

(54) T-Slot Mechanism and Assembly for Use in Furniture Constructions

(71) Applicant: Iconify Corp., Fairfield, CT (US)

(72) Inventors: Marci Sue Klein, Fairfield, CT (US); David Seth Klein, Fairfield, CT (US); Jesse S. Kruska, Wallingford, CT (US); David Mathieu, Colchester, CT (US)

(73) Assignee: Iconify Corp., Fairfield, CT (US)

(21) Appl. No.: 15/179,265

(22) Filed: Jun. 10, 2016

Related U.S. Application Data
(60) Provisional application No. 62/199,280, filed on Jul. 31, 2015.

(51) Int. Cl. F16B 12/14; A47B 81/06; A47B 47/00

(52) U.S. Cl. CPC F16B 12/14; A47B 47/0091; A47B 81/06; A47B 47/0058; A47B 2230/07; F16B 2012/145

(57) ABSTRACT

Assembly systems of particular use in assembling modular units, e.g., modular furniture, are provided. More particularly, a t-slot mechanism is provided that facilitates efficient, effective and aesthetic modular unit assembly.

### CROSS-REFERENCE TO RELATED APPLICATION

The present application claims priority benefit to a provisional patent application entitled “T-Slot Mechanism and Assembly for Use in Furniture Constructions,” which was filed on Jul. 31, 2015, and assigned Ser. No. 62/199,280. The entire content of the foregoing provisional application is incorporated herein by reference.

### TECHNICAL FIELD

The present disclosure is directed to advantageous assembly systems of particular use in assembling modular units, e.g., modular furniture, modular workstations and partition systems, and, more particularly, is directed to a t-slotted mechanism that facilitates efficient and effective modular unit assembly.

### BACKGROUND ART

It is known that modular frame constructions can be assembled using t-shaped grooves and connectors to join the vertical and horizontal framing members. Traditionally, these assemblies have been utilized as industrial structures, temporary dwellings, for erection of partitions, and the like.

Although workable, many such prior assemblies require that the connecting mechanism interferes with more than one face of the supporting vertical frame member. This prevents the ability for multiple horizontal members to attach to the vertical supporting member at the same height location. This requirement severely limits the function and modularity of such framing systems. Additionally, many of the previous designs have exposed fasteners and connections that obstruct the channels where stationary and/or sliding panels may rest. Furthermore, these exposed elements are not aesthetically pleasing to be used as furniture. Lastly, some of the previous connector designs require machining of the connector, which creates added costs.

In view of the shortcomings in prior connection mechanisms, a need exists for improved assembly systems and mechanisms that address the limitations of prior art assemblies and facilitate efficient, effective and aesthetically optimized modular unit assembly. These and other objects are satisfied by the systems/mechanisms disclosed herein.

### SUMMARY

The present disclosure is directed to modular furniture systems and associated connection systems/mechanisms that include, inter alia, T-shaped (t-slot) grooved frame members that incorporate and/or utilize advantageous “t-slot” mechanisms for connecting modular units relative to each other, e.g., for connecting vertical and horizontal support frames. The disclosed t-slot mechanism and the associated fastener are advantageously concealed within the support frames, thus eliminating any obstruction for stationary or sliding panels associated with modular furniture assemblies and providing a strong and aesthetically pleasing connection.

Additionally, the disclosed t-slot mechanism may be outfitted with additional hardware that may interface with the vertical support frame member to allow for indexing of the fastener and its corresponding horizontal frame member. Thus, the disclosed t-slot mechanism is flexible in use and supports a range of connections as part of a modular assembly.

The fastener components associated with the disclosed t-slot mechanism are easily fabricated and, in exemplary embodiments, may be stamped from a single piece of steel, thus reducing manufacturing costs.

Additional features, functions and benefits of the disclosed t-slot mechanism and its beneficial use in modular unit assemblies will be apparent from the description which follows, particularly when read in conjunction with the appended figures.

### BRIEF DESCRIPTION OF THE DRAWINGS

To assist those of skill in the art in making and using the disclosed connection assembly systems/mechanisms, reference is made to the appended figures wherein:

FIG. 1A shows an exemplary modular furniture assembly that may benefit from the disclosed t-slot mechanism/system.

FIG. 1B shows an exemplary modular furniture system that may benefit from the disclosed t-slot mechanism/system.

FIG. 1C shows an exemplary modular furniture system that may benefit from the disclosed t-slot mechanism/system.

FIG. 2 is a perspective view of an exemplary t-slot mechanism according to the present disclosure.

FIG. 3 is a side view, partially in phantom, showing exemplary embodiments of the disclosed t- slot mechanism in operation/use within a modular unit assembly that includes t-shaped grooves.

FIG. 4 is a perspective view, partially in phantom, showing a modular unit assembly that is assembled, at least in part, using the disclosed t-slot mechanism.

FIG. 5 is a perspective view of an alternative t-slot mechanism according to the present disclosure.

### DESCRIPTION OF EXEMPLARY EMBODIMENT(S)

As noted above, the present disclosure is directed to advantageous assembly systems of particular use in assembling modular units, e.g., modular furniture. The disclosed assembly systems generally include a t-slot mechanism that functions in cooperation with a t-shaped groove to facilitate efficient and effective modular unit assembly.

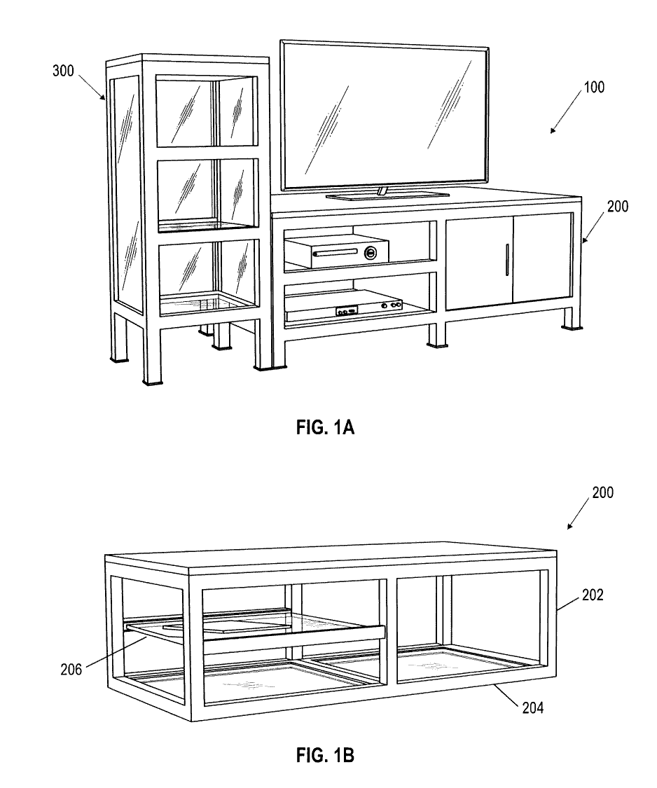

FIGS. 1A-1C illustrate the versatility of the modular furniture systems that may benefit from the disclosed t-slot mechanism described herein. In essence, the disclosed t-slot mechanism (not shown) may be employed in connecting any two framing members that include a t-shaped groove (not shown) associated with a first framing member and an associated square channel/opening in the second member for receipt of the securing portion of the disclosed t-slot mechanism to effectuate a desired connection.

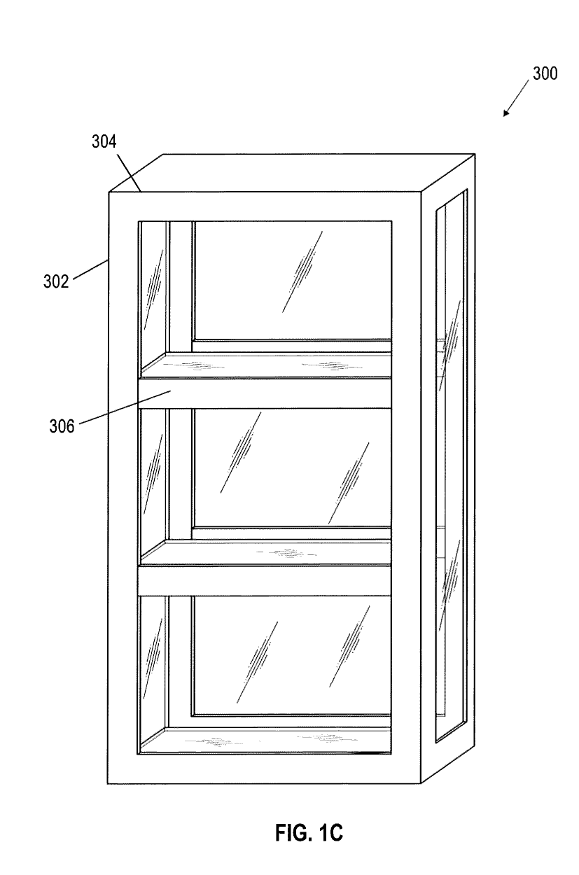

As shown in FIG. 2, an exemplary embodiment of the disclosed connector (10) is schematically depicted. Connector (10) is constructed with a flat back stop (20) that defines a substantially “M”-shaped geometry. At the center of the M-shaped back-stop (20), an extension arm (22) is formed that extends substantially perpendicular to back-stop (20). The extension arm (22) defines an undulating geometry such that a series of substantially “C”-shaped portions are formed along the extent of extension arm (22). More particularly, in the exemplary embodiment of FIG. 2, extension arm (22) includes a tab region (26) that extends from the back-stop (20), a first C-shaped undulation (28) joined to the tab region (26), an intermediate tab region (30) joined to the tab region (26) and a second C-shaped undulation (32) joined to the intermediate tab region (30). The undulating geometry of the disclosed extension arm (22) advantageously imparts a degree of flexibility to connector (10), facilitating a “flattening” deflection of the C-shaped undulations (28, 32) relative to the axis of the extension arm (22), e.g., when interacting with an associated channel, thereby establishing a connection force as between the disclosed connector (10) and the channel.

The height of the C-shaped undulations (28, 32) relative to the tab regions (26, 30) is generally selected to ensure effective interface with associated channels formed in modular units to be connected according to the present disclosure. However, in exemplary embodiments, the height and width of the C-shaped undulations may range from about 0.25 inches to about 0.3 inches. Similarly, the overall length of the extension arm (22) is generally selected to ensure effective interface with associated channels and to provide sufficient connective contact therebetween. In exemplary embodiments, the length of extension arm (22) may range from about 1.25 inches to about 1.5 inches, optimized to allow for easy use of standard length commercially available hardware, e.g., hex wrench. The length of the M-shaped back-stop is designed to afford maximal interface between the fastener and the associated vertical framing member, maximal prevention of rotation between the fastener and the framing member, and optimized to keep the fastener concealed from view behind the horizontal framing member being supported. This allows for improved aesthetics and functionality.

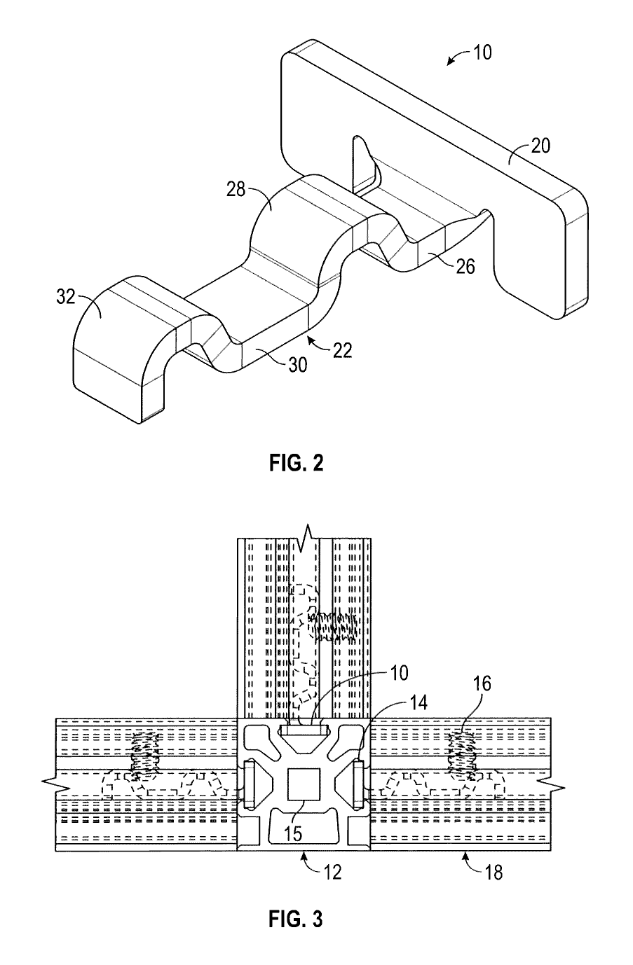

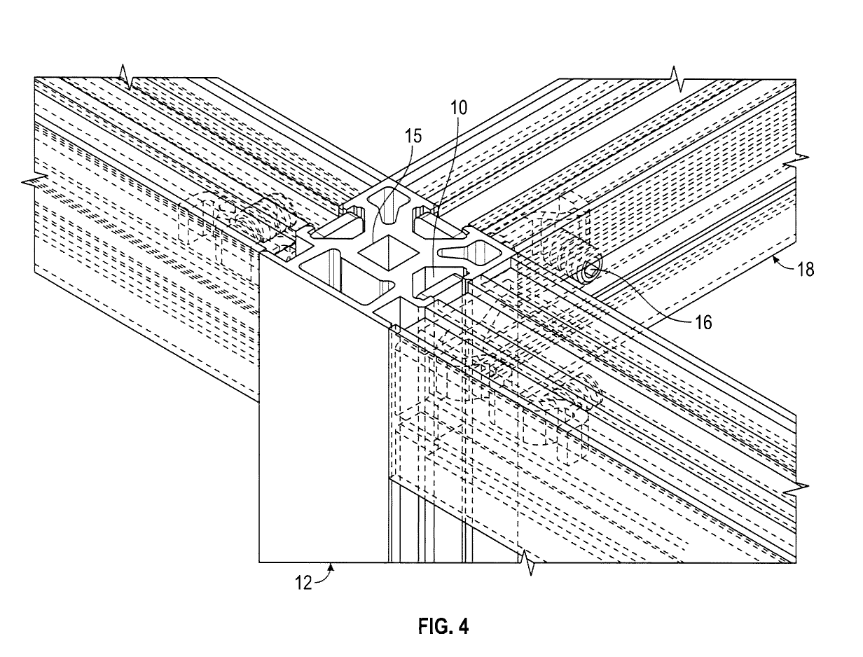

With reference to FIGS. 3 and 4, structural interaction between the disclosed connector and modular units is schematically depicted. As shown in the top view of FIG. 3 and the perspective view of FIG. 4, the back-stop (20) of connector (10) is configured/dimensioned to enter an extruded t-slot/groove (14) formed in a vertical support frame (12). The connector (10) can be oriented within the t- shaped channel of the extruded tube with its extension arm (22) facing inward, or outward, depending on the design of the structure being constructed/connected.

The central channel (15) within the horizontal framing member (18) that accepts the extension arm of the fastener is perfectly square, so as to allow this horizontal framing member (18) to be oriented upward, downward, inward or outward facing depending on the design of the structure being constructed/connected.

The outer edges of the top/bottom of back-stop (20) frictionally engage the inner walls of the t-slot/groove (14), but are free to move relative thereto for positioning at a desired vertical position (for the orientation depicted in FIG. 3). Although the t-slot/groove (14) is shown with a substantially triangular geometry, use of the disclosed connector (10) is not limited by or to interaction with such t-slot/groove geometry. Additionally, although the supporting framing members are depicted in associated figures with a particular geometry on non t-slotted sides, these non t-slotted sides may be altered in geometry for multiple desired functions or aesthetics without departing from the spirit or scope of the present disclosure.

The connector (10) can be adjusted along the extruded t-slot/groove (14) to a desired height or assembled at a preset location along a vertical support frame (12). Once the connector (10) is at a desired height, the horizontal support frame (18) may be fastened with respect to the connector (10) by introducing a set screw (16), concealed below the surface on the inward facing aspect of the horizontal support frame (18). Tightening the set screw (16) will generally engage the extension arm (22) of the connector (10) along an inner sloped portion of a C-shaped undulation, thereby putting the extension arm (22) of the connector (10) in tension. The back-stop of the connector presses against the extruded t-slot/groove (14) as the extension arm (22) is engaged by the set screw (26), thus restricting the horizontal support frame (18) from vertical movement. The tension caused by tightening the shown set screw (16) creates a pulling inward and downward deflection of the connector (10) and a spring-loaded effect of the extension arm of connector (10) against the back wall of the horizontal member (18). The geometry of the M-shaped back-stop prevents rotation of the connector within the t-slotted vertical member channel.

The geometry of the extension arm (22) is designed to fit the square geometry of the central channel (15) of the horizontal framing member (18), such that rotation is prevented and thereby maintaining the desired orthogonal relationship between the two framing members. The spring-loaded tension, created by tightening the setscrew angled against the horizontal frame member (18) wall, helps to maintain tightness of the connection.

Referenced before, FIG. 1A illustrates a common home use set-up (100), much like one that may be found in a living room. In this embodiment, the set-up (100) includes a single level stand (200), possibly used to hold a television and the accompanying digital boxes (i.e., cable box, gaming system, video player, and the like), and a three level shelf (300). The set-up (100) is only one example of the variety of arrangements that can be created using the advantageous t-slot mechanism of the present disclosure; the items as well as the furniture can be rearranged to meet the consumers' needs.

Specifically, in FIG. 1B, the vertical framing members (202) interface with the horizontal framing members (204), thereby utilizing the disclosed t-slot mechanism (not shown) in order to create a secure and aesthetically pleasing connection. The interface between the t-slot mechanism (not shown), the vertical framing member (202) and horizontal framing member (204) depend on the orientation of one framing member with respect to the other framing member. Said differently, when the central channel (not shown) of a first framing member is perpendicular to the t-slot/groove (not shown) of a second framing member, the first framing member will interface with the extension arm (not shown) of the t-slot mechanism (not shown) and the second framing member will interface with the M-shaped back-stop (not shown) via the t-slot/groove (not shown) of the second framing member. A set screw (not shown) engages the extension arm (not shown) to restrict the framing member from sliding/rotating.

In one embodiment, the central channel (not shown) of the horizontal framing member (204) perpendicularly abuts the interior t-slot/groove (not shown) of the vertical framing member (202), wherein the vertical framing member (202) would interface with the M-shaped back-stop (not shown) of the t-slot mechanism (not shown) and the horizontal framing member (204) would interface with the extension arm (not shown) of the t-slot mechanism (not shown). In another embodiment, the central channel (not shown) of the vertical framing member (202) perpendicularly abuts the interior t-slot/groove (not shown) of the horizontal framing member (204), wherein the horizontal framing member (204) would interface with the M- shaped back-stop (not shown) of the t-slot mechanism (not shown) and the vertical framing member (202) would interface with the extension arm (not shown) of the t-slot mechanism (not shown).

FIG. 1C illustrates a different arrangement from that of FIG. 1B, however, the interfacing methodology for connecting the vertical framing members (302) with the horizontal framing members (304) is substantially similar to that of FIG. 1B, discussed above. The shelves (206/306) can be mounted substantially similar to the interface between the vertical framing members and the horizontal framing members described above. In another embodiment, the shelves (206/306) are resting on clips and can be removed without affecting the structural integrity of the stand (200) and/or the three level shelf (300).

In another embodiment, the vertical and horizontal support members can have an exterior shape that is triangular, hexagonal or another polygonal shape. The change in exterior shape will not impact the t-slot mechanism; the connecting features (i.e. t-slot/groove and the square geometry of the central channel) will not change. The interface between the t-slot mechanism and the central channel are identical to the embodiments described above. The additional exterior shape designs provide more versatility in constructing furniture, wherein the horizontal support members can protrude at different angles from the vertical support member, thus allowing for different shaped structures. For example, an equilateral triangular vertical support member (i.e. 60 degrees) will enable a user to construct a different piece of furniture than if a square vertical support member (i.e. 90 degrees) was utilized.

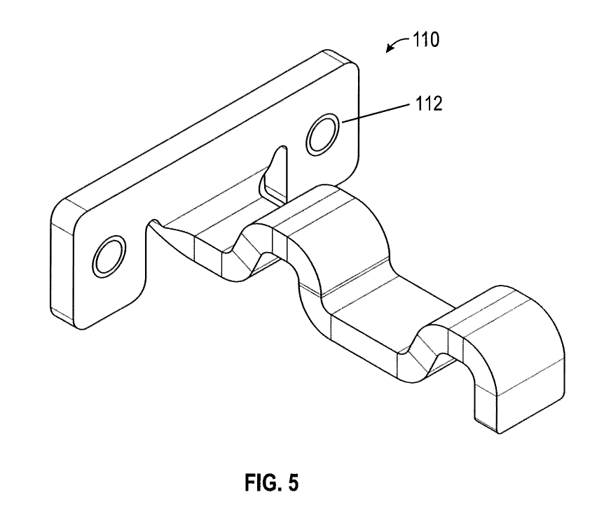

FIG. 5 displays another embodiment of the connector (10), where this connector (110) is outfitted with two holes (112) on either side of the back-stop of the connector that would interface with the vertical support frame (12). The connector (110) may interface with the vertical support frame (12) by way of a set screw or pin through either a threaded or thru hole (112). These holes (112) provide indexing capabilities on the vertical support frame (12) for installation at preset heights and added protection to avoid slippage between the support frames, should the constructed furniture unit be used to hold excessive weight.

In use, the disclosed systems offer numerous advantages. For example, an assembly may be provided that includes a vertical support frame, with a removable t-slot mechanism according to the present disclosure that may be used to join a horizontal support frame relative thereto. A set screw may be used to fasten the horizontal support frame to the t-slot mechanism. The t-slot mechanism may include a flat back stop designed to apply pressure to the extruded t-slot on the vertical support frame. The t-slot mechanism also includes undulations designed to restrict the horizontal support frame from rotating. The t-slot is concealed below the surface on the inward facing aspect of the horizontal support frame.

The t-slot mechanism may include a plurality (e.g., two) holes (112) formed therein that may be threaded or thru holes, on either side of the extension arm that would interface with a support frame by way of a set screw or pin, thereby locking the connector at the appropriate location. Additionally, by installing the set screws or pins, the connector can withstand an additional load, which is ideal for furniture.

The disclosed t-slot mechanism does not obstruct sliding panels that are installed along the vertical or horizontal support frames. In addition, the disclosed t-slot mechanism may be adjusted freely along the support frame. The t-slot mechanism may be placed at preset locations along either support frame and may be oriented with the extension arm facing in any direction (upward, downward, inward, or outward), depending on the structure being created. The disclosed t-slot mechanism may be constructed from a single flat piece of steel, e.g., by a stamping operation.

The set screw used to fix the t-slot mechanism in place is generally concealed below the surface of the horizontal support frame. Of note, the set screw may be replaced by a pin or other fastening element.

Although the present disclosure has been provided with reference to exemplary embodiments thereof, the present disclosure is not limited by or to such exemplary embodiments.

Rather, the present disclosure is susceptible to various modifications, refinements and/or variations without departing from the spirit or scope of the present disclosure.

1. A t-slot mechanism, comprising:
a. a back-stop;
b. an extension arm that extends from the back-stop, the extension arm defining an undulating geometry that includes a plurality of C-shaped portions.

2. The t-slot mechanism of claim 1, wherein the back-stop defines an M-shaped geometry.

3. The t-slot mechanism of claim 1, wherein the extension arm extends from substantially the center of the M-shaped geometry.

4. The t-slot mechanism of claim 1, wherein the extension arm includes two C-shaped portions.

5. The t-slot mechanism of claim 1, wherein the extension arm includes a tab region, a first C-shaped portion, an intermediate tab region and a second C-shaped portion.

6. The t-slot mechanism of claim 1, wherein the extension arm is substantially perpendicular to the back-stop.

7. The t-slot mechanism of claim 1, wherein the height and width of the C-shaped portions ranges from about 0.25 inches to about 0.3 inches.

8. The t-slot mechanism of claim 1, wherein the length of the extension arm ranges from about 1.25 inches to about 1.5 inches.

9. The connection system of claim 1, wherein the back-stop includes a plurality of holes that may be used to secure the t-slot mechanism in place.

10. A connection system, comprising:
a. t-slot mechanism that includes (i) a back-stop, and (ii) an extension arm that extends from the back-stop, the extension arm defining an undulating geometry that includes a plurality of C-shaped portions; and
b. a first structural unit that includes a t-slot configured and dimensioned to receive the back-stop of the t- slot mechanism;
c. a second structural unit that includes a channel configured and dimensioned for receipt of the extension arm of the t- slot mechanism; and
d. a set screw for introduction relative to the second structural unit;
wherein the set screw is effective to secure the extension arm within the channel of the second structural unit, thereby fixing the first structural unit relative to the second structural unit.

11. The connection system of claim 10, wherein the first structural unit includes a vertical support frame within which the t-slot is formed.

12. The connection system of claim 10, wherein the second structural unit defines a horizontal support frame.

13. The connection system of claim 11, wherein the t-slot mechanism is concealed below the surface of an inward-facing aspect of the horizontal support frame.

14. The connection system of claim 10, wherein the t-slot mechanism is constrained from rotation when inserted into the square channel of the horizontal support frame.

15. The connection system of claim 10, wherein the spring-loading effect of the connecting mechanism maintains connection between the support frame members throughout various working conditions.

16. The connection system of claim 10, wherein the non-connecting profiles of the vertical and horizontal framing members can be designed for additional functionality without altering the integrity of the connection mechanism.

17. The connection system of claim 15, wherein the additional features includes (i) rails for stationary and sliding panels, (ii) curved edges for aesthetics, and (iii) ledges for shelf support.
